(19) United States
(12) Patent Application Publication
(10) Pub. No.: US 2004/0146167 A1
(43) Pub. Date: Jul. 29, 2004

(54) Method and apparatus for processing audio from various sources

(75) Inventor: William G. Bennett, Vista, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: Sony Corporation/Sony Electronics Inc.

(21) Appl. No.: 10/690,189

(22) Filed: Oct. 21, 2003

Related U.S. Application Data
(60) Provisional application No. 60/442,279, filed on Jan. 24, 2003.

(51) Int. Cl. H04R 29/00

(52) U.S. Cl. 381/59; 381/58

(57) ABSTRACT

A method for processing audio from varying audio sources includes providing a variable audio response, including audio gain, balance and tonal quality setting on a per channel (or per source or both) basis that a user can adjust when setting up the receiver. For example, a user can establish a relative gain setting from −4 dB to +4 db in 2 dB increments, increment rear volume while increasing base response for the audio so that the audio is compensated in accordance with this setting before sending the audio to the speakers. This enables a user to account for those channels or sources that are out of the normal for the user in terms of loudness and tone, i.e., either the channels are too loud or too soft relative to most of the other channels or sources. Each channel or source would be preset to 0 dB, thereby providing no compensation. According to this method, the user first sets his volume control to a place where the user finds satisfactory. Then, when the user tunes to a given channel or source and notices that this channel typically requires the user to adjust the volume (either up or down), the user can adjust the automatic audio gain setting for this channel to account for this deviation. Other possible gain settings could be from −10 dB to +10 db in 1 dB or 2 dB increments, just to name one possible example. The user can also adjust the balance, tonal quality and other aspect of the audio signal as desired.

### STATEMENT OF RELATED APPLICATION

This application claims the benefit of priority to U.S. Provisional Patent Application 60/442,279, filed Jan. 24, 2003 by the same inventor, and entitled “Pre-setable Audio Gain Setting To Compensate For Program Source Head Room Volume.”

### FIELD OF THE INVENTION

The present invention relates generally to method and apparatuses for processing audio received from one or more sources, and more particularly to a method and apparatus for processing audio received from one or more sources, such as analog television, digital television, high definition television, cable television, satellite television, streaming internet data channels, etc.

### BACKGROUND

Generally, audio received in an analog television channel is equalized across the analog channels such that viewers do not need to adjust the volume setting when merely changing channels. Over the years, analog television broadcasters have learned to adjust the relative volumes of their programming to be consistent across the television spectrum. These adjustments have been made at the broadcast end.

With the advent of digital television, and therefore mixed analog/digital television channels, audio sources have different audio dynamics and audio head-room. These differences can often require a television viewer to adjust the volume of the amplifier to maintain constant loudness within his or her viewing area.

Several techniques have been proposed for addressing loudness issues with audio included in a received television channel. For example, there are some proposed standards that attempt to address some of these differences, but they are not currently followed and, in fact, do not cover all situations. One such proposed standard includes EIA/CEB 11, which attempts to address these issues, however, this standard is not enforceable and it does not address all audio sources, such as PCM.

Unfortunately, the problem still remains. Moreover, users are now using a common audio processor to process multiple types of video and audio sources at once. These include high definition television, digital television, analog cable television, digital cable television, satellite television, streaming audio, CD-writers, DVDs, digital radio, video games, and Internet radio to name only a few. These sources vary widely in their audio loudness levels. As a result, the situation is becoming exacerbated.

The present invention is therefore directed to the problem of developing a method and apparatus for controlling the volume, dynamic balance and tonal quality of received audio from multiple sources.

### SUMMARY OF THE INVENTION

The present invention solves these and other problems by providing an automatic audio response adjustment to compensate for each of the different sources of the audio.

According to one aspect of the present invention, a method for processing audio from one or more audio sources includes providing an audio adjustment on a per channel or per source basis that a user can adjust when setting up the receiver. For example, a user can establish a relative gain settings from −4 dB to +4 db in 2 dB increments for the audio while increasing the base response so that the received audio is compensated in accordance with this setting before sending the audio to the speakers. Other possible gain settings could be from −10 dB to +10 db in 1 dB or 2 dB increments, to name only a few possible variations. Tone and balance settings could also be established.

According to another aspect of the present invention, an apparatus for processing audio from one or more sources includes a user interface and an audio processor. The user interface enables the user to select one or more audio adjustments, such as gain, balance and tone offsets, for an audio signal to each of the one or more speakers. In addition, the user interface can permit the user to enter audio adjustments for each channel of a multi-channel source, such as cable television, satellite television, digital television or others. The audio processor receives an audio signal from a selected one of the one or more sources, adjusts a response of the audio signal from the selected one of the one or more sources and sends the adjusted audio signal to be output over one or more speakers.

According to another aspect of the present invention, the user interface includes a graphical user interface via which a user can select one of a predetermined number of audio adjustments, such as gain offsets, which are then used by the audio processor to adjust the response of the audio. The user interface can also provide the user the opportunity to select one of a predetermined number of audio adjustments, such as gain offsets, for each of the one or more sources, which is then used by the audio processor to adjust the response of the audio signal when said each of the one or more sources is selected by the user. Moreover, the user interface can provide the user the opportunity to select one of a predetermined number of audio adjustments for each of one or more channels in each of the one or more sources, which is then used by the audio processor to adjust the response of the audio signal when of the one or channels in each of the one or more sources is subsequently selected by the user.

According to another aspect of the present invention, the user interface can query the user upon the user selecting a source or a channel of a source for which no audio adjustment has been entered as to whether the user wishes to enter a an audio adjustment for the selected source or channel. Upon a positive response from the user, the user interface stores a received audio adjustment in a table in association with the selected source or channel for which no audio adjustment had been entered when selected by the user. The audio processor then controls a response of audio associated with the selected source or channel for which no audio adjustment had been entered when selected by the user in accordance with the received audio adjustment subsequently entered by the user.

According to yet another aspect of the present invention, an exemplary embodiment of a computer readable media has encoded thereon programming instructions that control a processor to perform the above-mentioned processes and methods.

Other aspects of the present invention will become apparent to those of skill in the art upon a review of the detailed description in light of the following drawings.

### BRIEF DESCRIPTION OF THE DRAWINGS

FIG. 1 depicts a method for processing audio from one or more audio sources according to one aspect of the present invention.

FIG. 2 depicts a block diagram of an apparatus for processing audio from one or more audio sources according to another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention provides an elegant solution to the problem of loudness differences among different audio sources, which can be implemented by those users most affected by the problem. The solution can be implemented within a basic tuning table to maintain a user gain offset for each channel or source, such as for example, +4, +2, 0, −2, −4 dB.

Additionally, one could also lump audio sources within a source material to have these offsets, i.e., all Dolby sources would have the same adjustable offset, all Dolby 5.1 sources would have the same adjustable offset, all PCM sources would have the same adjustable offset, and all analog sources would have the same adjustable offset, etc. Lumping of sources would not cover those not following the general broadcaster trend. As televisions and set-top boxes migrate to the digital world these variations will become annoying to the consumer, thereby providing more impetus for the above solution.

Sources can be globally compensated as well as individually. For example, all satellite television channels can be adjusted by a certain amount to account for the major differences between satellite channels as compared to cable television channels. And then within the satellite channels, each channel can be separately adjusted to account for variations among channels within the satellite broadcast.

According to one aspect of the present invention, a method for processing audio from varying audio sources includes providing an audio adjustment, such as a variable gain setting, on a per channel (or per source) basis that a user can adjust when setting up the receiver. For example, a user can establish a relative gain setting from −4 dB to +4 db in 2 dB increments for the audio so that the audio is compensated in accordance with this setting before sending the audio to the speakers. This enables a user to account for those channels or sources that are out of the normal for the user in terms of loudness, i.e., either the channels are too loud or too soft relative to most of the other channels or sources. Each channel or source would be preset to 0 dB, thereby providing no compensation. According to this method, the user first sets his volume control to a place where the user finds satisfactory. Then, when the user tunes to a given channel and notices that this channel typically requires the user to adjust the volume (either up or down), the user can adjust the automatic audio gain setting for this channel to account for this deviation. Other possible gain settings could be from −10 dB to +10 db in 1 dB or 2 dB increments, just to name one other possible variation. The exact values and increments used need not be limited to these examples. Other audio properties can be adjusted, such as tonal quality and balance to name only two possibilities.

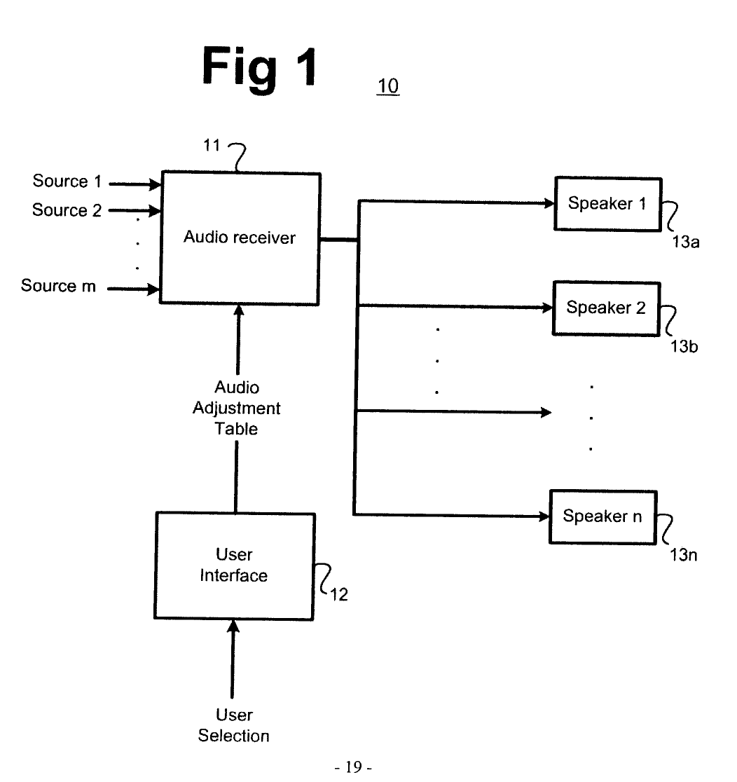

Turning to FIG. 1, shown therein is an apparatus 10 for processing audio from one or more sources (i.e., sources 1 through m). The audio receiver (which could be an amplifier, tuner, audio/video receiver, television, etc.) 11 receives a table from a user interface 12. In general, the audio receiver is simply an audio processor, i.e., a processor that handles audio signals.

The user interface 12 could be a graphical user interface that displays information on a display device, such as a television screen or monitor, and enables a user to select from a plurality of provided values or to adjust a bar or tuning knob to enter a value for each of the sources 1 through m. The user interface 12 can display for each channel of a television broadcast source, for example, a selectable gain value that can be used to adjust the audio for than broadcast channel. The user interface can include a keyboard, a display unit, and an input device, such as a remote control or other device for interacting with a user to obtain data. In one possible embodiment, the user interface includes a remote control and an interactive set of menus that steps the user through the process of entering gain offsets or other audio property adjustments for each of several sources. Within a given source, additional offsets can be entered for each channel in the source, such as in a cable television source.

Alternatively, the user could enter a value between a specified range to completely specify the gain adjustment or offset. For example, the user could enter 2.5 dB to specify the exact offset desired rather than selecting from among several predetermined offsets. In this case, the system would only permit values between two extremes, such as −20 dB or +20 db.

As an option, the first time the source is selected, the user interface could prompt the user to enter an audio adjustment, such as a gain offset or maintain the source as its original with no adjustments. Alternatively, each time a source is selected for which there is no audio adjustment, such as a gain offset, entered, the system could prompt the user to enter a value for the audio adjustments, such as a gain offset, default to unchanged, or set the audio adjustments another time.

Once the receiver 11 or audio processor has the audio adjustment for a given source, the receiver or audio processor can then adjust the output response of the audio embedded in the source in accordance with the selected adjustments. The resulting adjusted audio signal is then sent in the normal manner to the one or more speakers 13a-13n used in the system 10. An example of an audio processor comprises an audio/video receiver that handles multiple sources of audio and video. Portions of the audio/video receiver are conducted in the analog domain, while other portions are conducted in the digital domain. In either case, the adjustment of the volume can be accomplished with either an amplifier at the output side of the audio/video receiver, when the output is in analog format. Alternatively, the adjustment can be made in the digital domain by adding a digital value to the digital bits prior to their conversion to analog.

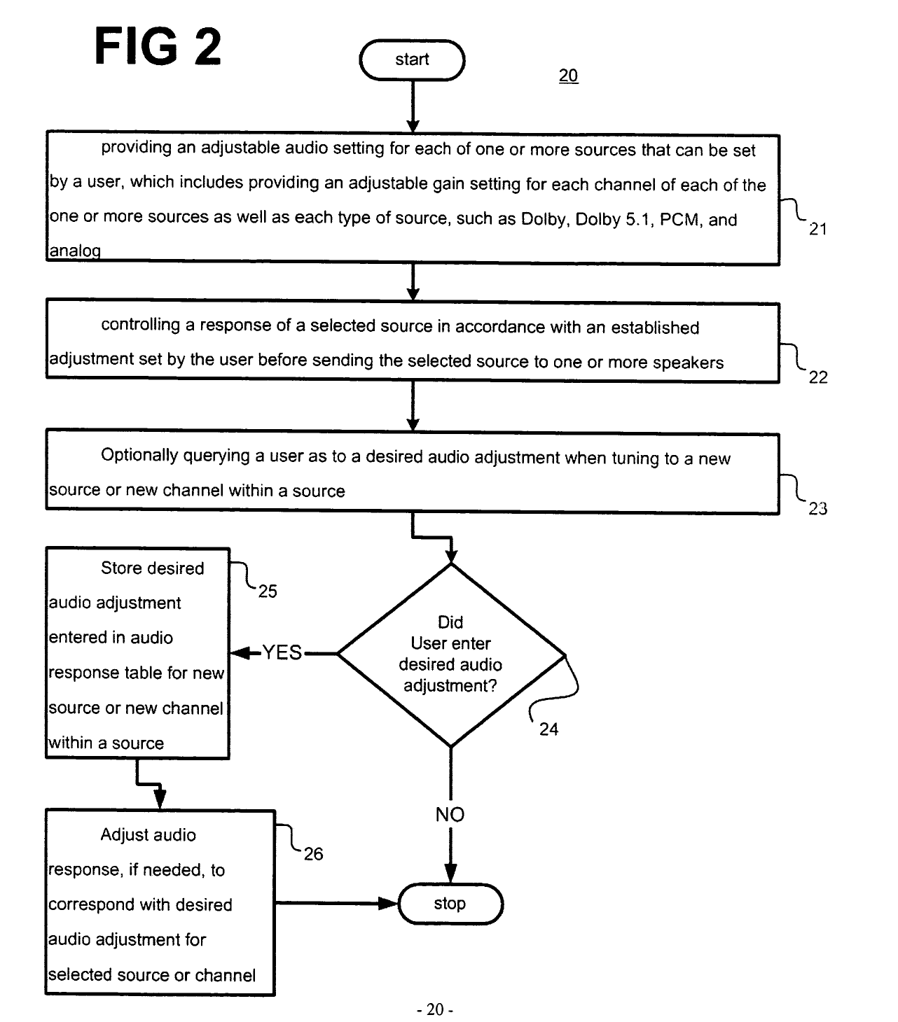

Turning to FIG. 2, shown therein is an exemplary embodiment of a method 20 for processing audio from one or more sources. According to this exemplary embodiment, an adjustable gain is provided for each of one or more sources that can be set by a user. This includes providing an adjustable gain setting for each channel of each of the one or more sources, as well as each type of source, such as Dolby, Dolby 5.1, PCM, Dolby 6.1, nine-channel audio (i.e., audio format in which there are three front speakers, three rear speakers, two front effects speakers and a subwoofer—sometimes referred to as surround sound), and analog (element 21).

Once the value or values are entered by the user, a response of a selected source is controlled in accordance with an established audio adjustment set by the user before sending the selected source to one or more speakers (element 22). For example, if the volume already meets or exceeds the maximum available output volume, nothing is modified. Similarly, if the minimum volume is already reached, nothing is adjusted. However, the audio response is modified prior to the audio signal being sent to the speakers. This can be accomplished in several places in the audio processing stream, either before conversion to an analog signal or afterwards. In either case, this adjustment can be made with little modification in hardware.

If the user tunes to a new channel or source for the first time (or no audio adjustments have been previously entered for the new channel or source), the user can be queried as to whether he wishes to enter any audio adjustments for this channel (element 23). If the user enters a value in response to the query (as determined in element 24), the value is stored in the table in association with the new channel or source (element 25), which table is accessible by the receiver.

The receiver or audio processor then adjusts the response of the audio signal to correspond with the desired value or values entered by the user (element 26).

If no value is entered, the process ends.

According to yet another aspect of the present invention, an exemplary embodiment of a computer readable media has encoded thereon programming instructions that control a processor to perform the above-mentioned processes and methods. For example, the processor is caused to establish an adjustable setting for each of the one or more sources that can be set by a user, and control a response of a selected source in accordance with an established adjustments set by the user before sending the selected source to one or more speakers. Moreover, the processor is caused to query the user upon the user selecting a source or a channel of a source for which no audio adjustments have been entered as to whether the user wishes to enter any audio adjustments for the selected source or channel and store a received audio adjustment in a table in association with the selected source or channel for which no audio adjustment had been entered when selected by the user. In addition, the processor may be instructed to control a response of the audio associated with the selected source or channel for which no audio adjustment had been entered when selected by the user in accordance with the received audio adjustment subsequently entered by the user. Examples of computer readable media include without limitation CD-ROMs, DVDs, magnetic memory storage, RAM, ROM, hard drives, memory sticks, optical memory, etc.

In addition, while only volume, balance and tonal qualities are discussed, the user can create any desired audio response for each selected channel on a per channel or per source basis to compensate for variations among channels or sources. Thus, the adjustments are not limited to these three, but could apply to any property of an audio signal.

Although various embodiments are specifically illustrated and described herein, it will be appreciated that modifications and variations of the invention are covered by the above teachings and are within the purview of the appended claims without departing from the spirit and intended scope of the invention. For example, certain values are discussed for the range and increments of the adjustable offsets; however, other values could be employed without departing from the scope of the invention. Furthermore, this example should not be interpreted to limit any modifications and variations of the invention that are covered by the claims but is merely illustrative of one possible variation.

What is claimed is:

1. A method for processing audio from one or more sources comprising:
providing an adjustable audio setting for each of the one or more sources that can be set by a user; and
controlling an audio signal of a selected source in accordance with an established adjustable setting set by the user before sending the selected source to one or more speakers.

2. The method according to claim 1, wherein the adjustable audio setting includes a gain offset.

3. The method according to claim 1, wherein the adjustable audio setting includes a balance setting.

4. The method according to claim 1, wherein the adjustable audio setting includes a tonal setting.

5. The method according to claim 1, wherein the providing further comprises providing an adjustable setting for each channel of a received television signal.

6. The method according to claim 1, wherein the providing further comprises providing an adjustable setting for each type of audio source.

7. The method according to claim 6, wherein each type of audio source includes one or more of the following: Dolby, Dolby 5.1, Dolby 6.1, PCM, and analog.

8. The method according to claim 1, wherein the adjustable setting includes a gain offset that can be selected in predetermined steps.

9. The method according to claim 1, wherein the adjustable setting includes a gain offset that ranges from −4 db to +4 db in 2 db increments.

10. The method according to claim 1, wherein the adjustable setting includes a gain offset that ranges from −10 db to +10 db in 1-2 db increments.

11. The method according to claim 1, further comprising querying the user upon the user selecting a source or a channel of a source for which no adjustable setting has been entered as to whether the user wishes to enter an adjustable setting for the selected source or channel.

12. The method according to claim 11, further comprising storing a received adjustable setting in a table in association with the selected source or channel for which no adjustable setting had been entered when selected by the user.

13. The method according to claim 12, further comprising controlling an audio response of the audio associated with the selected source or channel for which adjustable setting had been entered when selected by the user in accordance with the received adjustable setting subsequently entered by the user.

14. An apparatus for processing audio from one or more sources comprising:
a user interface via which a user can select an adjustable setting for an audio signal from each of the one or more sources; and
an audio processor receiving an audio signal from a selected one of the one or more sources, adjusting a response of the audio signal from the selected one of the one or more sources in accordance with the user selected adjustable setting and sending the adjusted audio signal to be output over one or more speakers.

15. The apparatus according to claim 14, further comprising a storage unit storing a table, each value for which is received from the user interface and is associated with a source or a channel within a source and said audio processor retrieves one or more particular values from the table when a particular source or particular channel within a source is selected by the user and said one or more particular values are associated with said particular source or particular channel within a source.

16. The apparatus according to claim 14, wherein the user interface comprises a graphical user interface via which a user can select one of a predetermined number of gain offsets, which are then used by the audio processor to adjust the gain.

17. The apparatus according to claim 14, wherein the user interface comprises a graphical user interface via which a user can select one of a predetermined number of audio adjustments, which are then used by the audio processor to adjust the audio signal.

18. The apparatus according to claim 18, wherein the predetermined number of audio adjustments includes a balance setting in predetermined steps.

19. The apparatus according to claim 18, wherein the predetermined number of audio adjustments includes a tonal setting in predetermined steps.

20. The apparatus according to claim 14, wherein the user interface provides the user the opportunity to select one of a predetermined number of audio adjustments for each of the one or more sources, which is then used by the audio processor to adjust an audio response of the audio signal when said each of the one or more sources is selected by the user.

21. The apparatus according to claim 14, wherein the user interface provides the user the opportunity to select one of a predetermined number of audio adjustments for each of the one channels in each of the one or more sources, which is then used by the audio processor to adjust an audio response of the audio signal when said each of the one or channels in each of the one or more sources is selected by the user.

22. The apparatus according to claim 14, wherein the user interface queries the user upon the user selecting a source or a channel of a source for which no audio adjustment has been entered as to whether the user wishes to enter an audio adjustment for the selected source or channel.

23. The apparatus according to claim 22, wherein the user interface stores a received audio adjustment in a table in association with the selected source or channel for which audio adjustment had been entered when selected by the user.

25. The apparatus according to claim 14, wherein the audio processor controls a response of audio associated with the selected source or channel for which no audio adjustment had been entered when selected by the user in accordance with the received audio adjustment subsequently entered by the user.

26. A computer readable media having encoded thereon programming instructions causing a processor to:
establish an audio adjustment for each of the one or more sources that can be set by a user; and
control an audio response of a selected source in accordance with an established audio adjustment set by the user before sending the selected source to one or more speakers.

27. The computer readable media according to claim 26, wherein the programming instructions further cause the processor to:
query the user upon the user selecting a source or a channel of a source for which no audio adjustment has been entered as to whether the user wishes to enter a an audio adjustment for the selected source or channel;
store a received gain offset in a table in association with the selected source or channel for which no audio adjustment had been entered when selected by the user; and
control an audio response of the audio associated with the selected source or channel for which no audio adjustment had been entered when selected by the user in accordance with the received audio adjustment subsequently entered by the user.
